(19) United States
(12) Patent Application Publication
(10) Pub. No.: US 2010/0101904 A1
(43) Pub. Date: Apr. 29, 2010

(54) ADAPTIVE DAMPING MAIN STAGE VALVE

(76) Inventors: Stephen Rumple, Birmingham, MI (US); Franz Samson, Highland, MI (US)

Correspondence Address: CARLSON, GASKEY & OLDS, P.C., 400 WEST MAPLE ROAD, SUITE 350, BIRMINGHAM, MI, 48009, US

(21) Appl. No.: 12/259,449

(22) Filed: Oct. 28, 2008

(51) Int. Cl. F16F 9/34

(52) U.S. Cl. 188/322.13; 188/322.15

(57) ABSTRACT

A vehicle suspension component includes a shock absorber movable between rebound and compression positions and an external valve in fluid communication with the shock absorber to control shock absorber stiffness. The external valve has a valve housing, a piston received within the valve housing, and a blow-off ring movable relative to the piston between an initial position and a blow-off position. At least one deflection disc has a preload to bias the blow-off ring toward the initial position and the blow-off ring is movable to the blow-off position when fluid pressure exceeds the preload.

### TECHNICAL FIELD

The subject invention relates to an external valve for a shock absorber, and more specifically relates to an adaptive damping main stage valve with at least one deflection disc.

### BACKGROUND OF THE INVENTION

Suspension components, such as shock absorbers for example, are used to damp road load inputs to a vehicle body. Some shock absorbers can be “tuned” to control or vary stiffness of the shock absorber, which in turn affects ride and handling characteristics. A stiffer shock absorber may be better for handling purposes but can adversely affect ride comfort. Conversely a softer shock absorber may be better for ride comfort but can adversely affect handling.

In one known configuration, an external valve is fluidly connected to a shock absorber to control stiffness of the shock absorber. The external valve has a pilot portion and a main stage portion that includes a piston and blow-off ring that are received within a valve housing. A coil spring biases the blow-off ring to a closed position. When pressure against the main stage exceeds a biasing force of the spring, the blow-off ring is moved to a blow-off position. The valve is tuned by varying orifice size in the pilot portion and by setting the spring preloads and rates.

The use of coil springs to set the blow-off pressure makes the valve difficult to tune in an accurate and repeatable manner. Further, the coil springs create a side load on valve components that can result in premature wear and failure.

### SUMMARY OF THE INVENTION

The external valve has a valve housing, a piston received within the valve housing, and a blow-off ring movable relative to the piston between an initial position and a blow-off position. At least one deflection disc has a preload to bias the blow-off ring toward the initial position and the blow-off ring is movable to the blow-off position when fluid pressure exceeds the preload.

In one example, the external valve is used with a vehicle suspension component, such as a shock absorber for example. The shock absorber is movable between rebound and compression positions, and the external valve is in fluid communication with the shock absorber to control stiffness of the shock absorber.

These and other features of the present invention can be best understood from the following specification and drawings, the following of which is a brief description.

### BRIEF DESCRIPTION OF THE DRAWINGS

FIG. 1 is a schematic view of a shock absorber and external valve assembly with a main stage incorporating the subject invention.

FIG. 2 is a cross-section of the main stage in a closed position.

FIG. 3 is a cross-section of the main stage in an open position.

### DETAILED DESCRIPTION OF THE PREFERRED EMBODIMENT

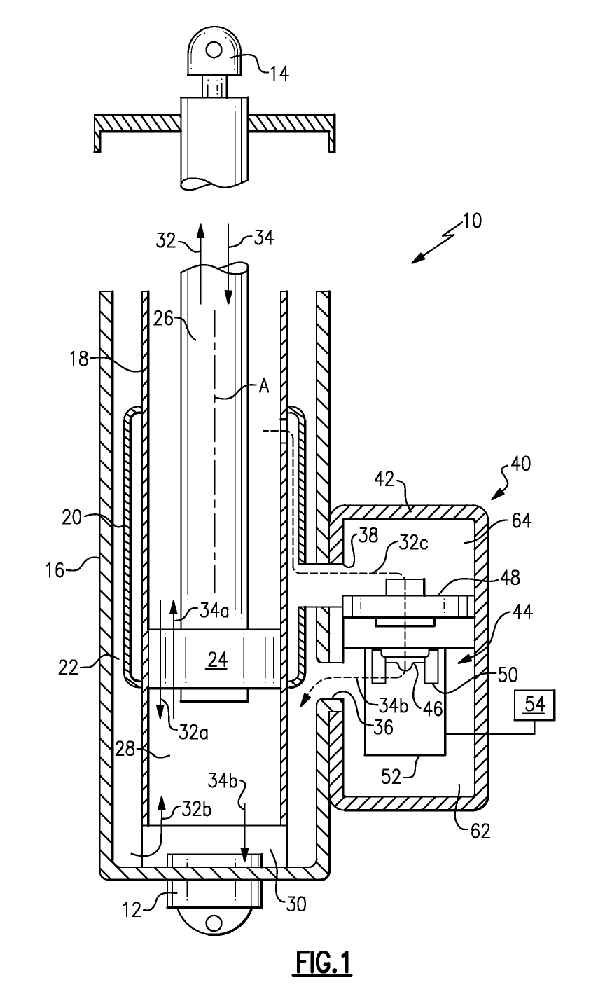

FIG. 1 is a schematic view of a shock absorber 10 that includes a wheel mount structure 12 that is mountable to a vehicle wheel component and a vehicle mount structure 14 that is mountable to a vehicle structure such as a frame or chassis, for example. The shock absorber 10 includes an outer housing 16, an inner housing 18, and an intermediate tube 20 positioned within a cavity 22 formed between the outer 16 and inner 18 housings. A piston 24 is connected for movement with a rod 26 and is received within a cavity 28 formed within the inner housing 18. A foot valve 30 is also received within a bottom of the cavity 28.

The movement of the rod 26 between rebound 32 and compression 34 strokes causes the piston 24 to reciprocate back and forth along an axis A defined by the rod 26 to damp road load inputs as known. It should be understood that while the rod 26 is shown as being connectable to the vehicle structure and the outer housing 16 is shown as being connectable to the wheel component, a reverse configuration could also be used.

The shock absorber 10 includes first 36 and second 38 ports that communicate with an external valve 40, which comprises a continuously adjustable/adaptable valve that can control shock absorber stiffness. During rebound strokes, fluid flows through the shock absorber 10 and external valve 40 as indicated by the arrows 32a-c. During compression strokes, fluid flows through the shock absorber 10 and external valve 40 as indicated by the arrows 34a-c. It should be understood that while the configuration of FIG. 1 shows an outer housing 16 with an intermediate tube 20 and inner housing 18, the external valve 40 could also be used with other shock configurations using different combinations of tubes and housings, i.e. fewer or more tubes or housings.

The external valve 40 includes a valve housing 42 that defines an interior cavity 44. The external valve 40 comprises a pilot portion 46 and a main stage 48 that are received within the interior cavity 44. In one example, the pilot portion 46 includes a sleeve 50 that is movable by a solenoid 52 to vary an amount of fluid flow through the pilot portion 46. It should be understood that while the pilot portion 46 is shown to include a sleeve, the pilot portion can take many different forms. The pilot portion simply needs to be orifice adjustable based on electrical current supplied to the solenoid 52. The solenoid 52 is powered by a power source 54 as known.

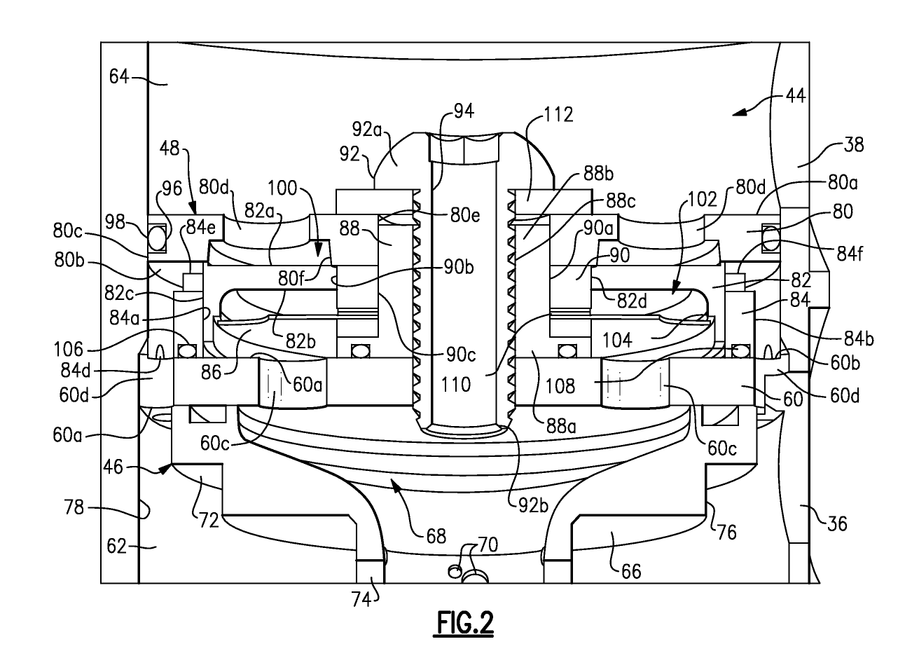

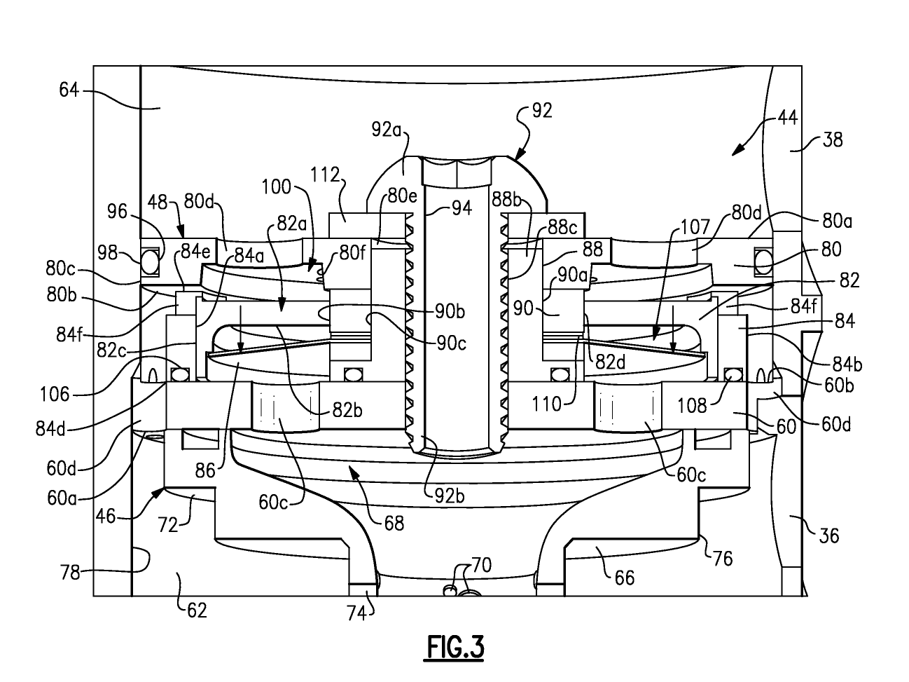

The external valve 40 is shown in greater detail in FIGS. 2-3. FIG. 2 shows the main stage 48 in a closed position and FIG. 3 shows the main stage 48 in an open position. The valve housing 42 includes a plate 60 that separates the interior cavity 44 into first 62 and second 64 chambers. The plate 60 has a first side 60a facing the first chamber 62 and a second side 60b facing the second chamber 64. One or more plate ports 60c extend through the plate 60 to fluidly connect the first 62 and second 64 chambers at the pilot portion 46. One or more plate holes 60d are formed radially outwardly of the plate ports 60c to direct fluid flow from the second chamber 64 to the first chamber 62 during a blow-off event. The first chamber 62 is fluidly connected with the shock absorber 10 via the first port 36 and the second chamber 64 is fluidly connected with the shock absorber 10 via the second port 38. The plate 60 is formed as one piece with the valve housing 42 but could also be a separately installed piece.

In this example configuration, the pilot portion 46 is received within the first chamber 62 and includes a pilot valve body 66 defining an interior pilot chamber 68. The pilot valve body 66 includes a plurality of pilot orifices 70 (only two are shown) that fluidly connect the pilot chamber 68 to the first chamber 62. Movement of the sleeve 50 (FIG. 1) relative to the pilot valve body 66 varies the flow rate between the pilot chamber 68 and first chamber 62 by covering and uncovering the pilot orifices 70. The pilot valve body 66 includes a base portion 72 that rests against the plate 60 and a stem portion 74 of reduced diameter that supports the sleeve 50. The stem portion 74 includes the pilot orifices 70. An outer surface 76 of the base portion 72 has a stepped profile and is spaced inwardly of an inner surface 78 of the valve housing 42. The shape and size of the base 72 and stem 74 portions can be varied as needed to further control fluid flow within the first chamber 62. Further, as discussed above, the pilot portion 46 can be done in many different ways and simply needs to be orifice adjustable based on electrical current supplied to the solenoid 52.

The main stage 48 is received within the second chamber 64 and includes a piston 80, a blow-off ring 82, a sealing ring 84, and at least one deflection disc 86. At least first 88 and second 90 spacers and a bolt 92 are used to secure the piston 80 to the plate 60 such that the piston 80 is immovable relative to the plate 60. The bolt 92 includes a central hole 94 that fluidly connects the second chamber 64 to the pilot chamber 68. The central hole 94 extends through an entire length of the bolt 92 from a head portion 92a to a distal threaded end portion 92b.

The piston 80 includes a first side 80a facing the second chamber 64 and a second side 80b that faces the plate 60. The first 80a and second 80b sides are connected by an outer peripheral surface 80c that extends about a periphery of the piston 80. A groove 96 is formed within the outer peripheral surface 80c and a seal 98, such as an O-ring for example, is received within the groove 96. The piston 80 includes at least one piston port 80d (two are shown) that extends through the piston from the first side 80a to the second side 80b.

A recess 100 is formed within the second side 80b of the piston 80 to form a fluid chamber. The piston ports 80d fluidly connect the second chamber 64 to this recess 100. Positioned over this recess 100 is the blow-off ring 82. The blow-off ring 82 includes a first side 82a that faces the piston 80 and a second side 82b that faces the plate 60. The first 82a and second 82b sides are connected by an outer peripheral surface 82c that extends about a periphery of the blow-off ring 82. The blow-off ring 82 also includes a bolt opening 82d that receives the bolt 92.

A recess 102 is formed within the second side 82b of the blow-off ring 82 to receive the at least one deflection disc 86. A lip or ledge 104 is formed within an inner peripheral surface that defines the recess 102. An outer edge of the deflection disc 86 rests against this ledge 104 when the deflection disc 86 is in an initial position with the main stage being closed. The deflection disc 86 is comprised of a resilient material that exerts a preload to hold the blow-off ring 82 in an initial or closed position against the piston 80. When a pressure force exceeds this preload force, the blow-off ring 82 moves off of the piston 80 to a blow-off position, i.e. main stage open position, as shown in FIG. 3. The preload of the deflection disc 86 can be varied by increasing or decreasing the number of deflection discs 86.

The sealing ring 84 includes an inner peripheral surface 84a and an outer peripheral surface 84b. inner peripheral surface 84a completely surrounds and directly abuts against the outer peripheral surface 82c of the blow-off ring 82. One edge 84d of the sealing ring 84 abuts directly against the second side 60b of the plate 60 and an opposite edge 84e directly abuts against the second side 80b of the piston 80. A groove 106 is formed within the one edge 84d to receive a seal 108, such as an o-ring for example. Slots 84f are formed within the sealing ring 84 to direct fluid outwardly of the sealing ring 84 during a blow-off event, i.e. when the main stage 48 is opened.

The first spacer 88 includes an enlarged head portion 88a and a stem portion 88b that extends from the enlarged head portion 88a toward the piston 80. An opening 88c extends through the stem portion 88b and head portion 88a to receive the bolt 92.

The second spacer 90 comprises a circular ring having an inner peripheral surface 90a and an outer peripheral surface 90b. The second spacer 90 includes an opening 90c that receives the bolt 92. One or more washers 110 are positioned between the second spacer 90 and the enlarged head portion 88a of the first spacer 88. The washers 110 assist in setting the preload for the blow-off ring 82.

The piston 80 also includes a central hole 80e that receives the bolt 92 and the stem portion 88b of the first spacer 88. The second spacer 90 rests on a raised boss portion 80f of the piston 80. The inner peripheral surface 90a abuts directly against the stem portion 88b of the first spacer 88. The outer peripheral surface 90b of the second spacer 90 abuts directly against a surface that defines the bolt opening 82d of the blow-off ring 82.

To secure the piston 80 to the plate 60, openings 80e, 88c, 90c of the piston 80, first spacer 88, and second spacer 90 are aligned with each other and then the bolt 92 is installed. The bolt 92 is tightened until the sealing ring 84 is pressed securely against the plate 60. A washer 112 can also be used to provide an abutment surface for the head portion 92a of the bolt 92 during tightening. Once the bolt 92 is installed, the piston 80, sealing ring 84, first spacer 88, and second spacer 90 are all held in a fixed position, i.e. these components do not move during operation of the valve. Only the blow-off ring 82 and deflection disc 86 move during operation.

Operation of the shock absorber 10 and associated external valve 40 is as follows. When fluid flows in through the second port 38 at a low pressure flow rate, the fluid flows through the center opening 94 of the bolt 92 and into the pilot chamber 68 of the pilot valve body 66. The pilot orifices 70 can be adjusted by applying current to the solenoid 52 as discussed above. Flow through the pilot portion 46 then exhaust through the first port 36 as shown in FIG. 2.

Depending upon the size of the pilot orifices 70, back pressure is generated against the blow-off ring 82. The smaller the size, or the more restricted the flow rate is through the orifices 70, the greater the back pressure. The back pressure is communicated to the blow-off ring 82 through the piston ports 60c. When fluid flowing through the second port 38 reaches a high enough flow rate, a greater pressure is created against one side of the main stage 48 than the opposite side. Once this pressure differential increases to exceed the preload exerted by the deflection disc 86, the blow-off ring 82 shifts from the initial position to the blow-off position (FIG. 3) and fluid flows through piston ports 60c, through slots 84f in the sealing ring 84, through holes 60d in the plate 60 and then out through the first port 36. As such, the opening in the pilot portion 46, i.e. the size/quantity of open pilot orifices 70, determines what pressure is needed to open the main stage 48, i.e. what pressure is needed to move the blow-off ring 82 to the blow-off position.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A vehicle suspension component comprising:
a shock absorber movable between rebound and compression positions; and
an external valve in fluid communication with said shock absorber to control stiffness of said shock absorber, said external valve including a valve housing, a piston received within said valve housing, a blow-off ring movable relative to said piston between an initial position and a blow-off position, and at least one deflection disc have a preload to bias the blow-off ring toward said initial position wherein said blow-off ring is movable to said blow-off position when fluid pressure exceeds said preload.

2. The vehicle suspension component according to claim 2 wherein said at least one deflection disc is comprised of a resilient material such that said at least one deflection disc forces said blow-off ring to return to said initial position when fluid pressure falls below said preload.

3. The vehicle suspension component according to claim 1 wherein said valve housing includes a plate portion that separates an interior cavity of said valve housing into first and second chambers and wherein said valve housing includes at least first and second ports, wherein said first port fluidly connects said first chamber and an interior chamber of said shock absorber and wherein said second port fluidly connects said second chamber and another interior chamber of said shock absorber.

4. The vehicle suspension component according to claim 3 wherein said external valve comprises an adaptive damping valve that includes a pilot portion received within said first chamber and a main stage received within said second chamber, said main stage including said piston, said blow-off ring, and said at least one deflection disc.

5. The vehicle suspension component according to claim 4 wherein said pilot portion includes a pilot chamber and at least one orifice opening that fluidly connects said pilot chamber to said first chamber.

6. The vehicle suspension component according to claim 5 wherein said main stage includes a sealing ring that is in abutting contact with said plate portion and said piston.

7. The vehicle suspension component according to claim 6 including a fastener fixing said piston to said plate portion, said fastener including a central hole that fluidly connects said second chamber to said pilot chamber.

8. The vehicle suspension component according to claim 7 wherein said sealing ring surrounds an outer peripheral surface of said blow-off ring and wherein said blow-off ring includes an inner peripheral surface that defines a recess, said at least one deflection disc being received within said recess.

9. The vehicle suspension component according to claim 5 including a solenoid operable to adjust a size of said at least one orifice opening in said pilot portion.

10. An adaptive damping valve for a suspension component comprising:
a valve housing including at least first and second chambers;
a pilot portion received within said first chamber; and
a main stage received within said second chamber, said main stage including a piston, a blow-off ring movable relative to said piston between an initial position and a blow-off position, and at least one deflection disc that has a preload to bias said blow-off ring toward said initial position.

11. The adaptive damping valve according to claim 10 wherein said valve housing includes a plate portion that separates an interior cavity of said valve housing into said first and second chambers and wherein said valve housing includes at least first and second ports, wherein said first port is in fluid communication with said first chamber and said second port is in fluid communication with said second chamber.

12. The adaptive damping valve according to claim 11 wherein said pilot portion includes a pilot chamber and at least one orifice opening that fluidly connects said pilot chamber to said first chamber.

13. The adaptive damping valve according to claim 12 wherein said main stage includes a sealing ring that is in abutting contact with said plate portion and said piston.

14. The adaptive damping valve according to claim 13 including a fastener fixing said piston to said plate portion, said fastener including a central hole that fluidly connects said second chamber to said pilot chamber.

15. The adaptive damping valve according to claim 13 wherein said sealing ring surrounds an outer peripheral surface of said blow-off ring and wherein said blow-off ring includes an inner peripheral surface that defines a recess, said at least one deflection disc being received within said recess.

16. The adaptive damping valve according to claim 10 wherein said at least one deflection disc is comprised of a resilient material such that said at least one deflection disc forces said blow-off ring to return to said initial position when fluid pressure falls below said preload.
